(19) United States
(12) Patent Application Publication
(10) Pub. No.: US 2003/0147164 A1
(43) Pub. Date: Aug. 7, 2003

(54) Wide range rearview mirror

(76) Inventor: Jack Sing Chiow Chan, Sugar Land, TX (US)

Correspondence Address: Jack Chan Sing Chiow, 11830 Pedernales Falls, Sugarland, TX, 77478, US

(21) Appl. No.: 10/312,249

(22) PCT Filed: Jan. 17, 2001
(86) PCT No.: PCT/US01/01885

(51) Int. Cl. G02B 5/10

(52) U.S. Cl. 359/868

(57) ABSTRACT

A rearview mirror apparatus consisting of wide range rearview mirror having cover (1), holder (2) and hanger (3) for providing a full rearview for vehicle drivers.

### TECHNICAL FIELD

The subject invention is related to an improvement of road safety by providing a Wide Range Rearview Mirror to motor vehicles. The subject invention is more directly related to improve driving safety by providing the invented Wide Range Rear View Mirror to be installed on both sides of the motor vehicles. The subject invention is yet more directly related to an improvement of driving safety while changing lanes. The subject invention is further more directly related to an improvement of driving safety as the wide range rear view mirror with a center curve extending to both edges covers all the blind spots. Finally, the subject invention relates to driving safety of cars, vans, trucks, buses and trailers, when the invented Wide Range Rear View Mirrors are installed to the vehicles.

### BACKGROUND ART

Manufacturing Wide Range Rear View Mirror at different sizes for various types of vehicles is a prior art.

The obvious benefit of providing Wide Range Rear View Mirror installed on both sides of the vehicles is providing the drivers with full rear view without blind spots. The rapid growth of vehicles in the world in the past (two) 2 decades, has attributed to the increase of road accidents, many of which occurred while changing lanes.

The obvious benefit is driving safety. Every time the driver looks at the Wide Range Rear View Mirrors on both sides, he/she will have full views and knows the traffic flows at the rear and the following of vehicles.

The additional benefit is that the driver of the vehicle now need not bend forward his/her body and look at the rear view mirror in order to cover the blind spots. He/She can now sit comfortably and look at the Wide Range Rear View Mirror and have the full view before changing lanes. Presently, more often than not the driver is shocked when a vehicle passed through when he/she is intending to change lanes. Due to haste, lack of experience, bad judgement, and blind spots, had always resulted in a higher rate of vehicular collisions.

The present safety hazards, apart from driving habits, the youngsters would like to speed and overpass the vehicles in front by cutting into lanes. It would also be seen that some truck drivers speed in zig-zagging on highways. In this situation, accidents occurred when the front vehicles are changing lane. It is due to the blind spots of the rear view mirrors, the speeding vehicle from the rear was not seen. The invention, Wide Range Rear View Mirror is to remedy the situation.

### DISCLOSURE OF INVENTION

The present invention is an improvement to the rear view mirrors of motor vehicles including cars, vans, trucks, buses and trailers. It is a safety device which could enhance driving safety and reduce road accidents. Additionally, the invention could avoid life and property loss as road accidents due to the blind spots in the rear view mirror are eliminated. The invention, Wide Range Rear View Mirrors installed on both sides of vehicle provide a full range of rear view for the drivers. The drivers could have the full rear view and could make the right judgement while changing lanes.

The road accidents occurred due to the blind spots of the present rear view mirror have been experienced by many drivers. The collisions in changing lanes were usually critical. There were many recurrences of cases especially when the drivers were not in full concentration. The loss of life and properties are tragedies. The insurance claims on injuries, loss of life and properties are tremendous. These are the losses of a country or a nation. There are losses of time and efforts in dealing with the accidents by traffic police and medical professionals. The time wasted in court administration for preparing reports, documents and papers for Court hearings, etc. If all these are converted into measurement in monetary term, the cost would be hundred of millions of dollars per year for a country and for global would be billions of dollars. The obvious benefits contributed by the invention of the Wide Range Rear View Mirror are noticeable. The main motive of the inventor is to save life and eliminate tragedy as far as possible.

The Wide Range Rear View Mirror for distinguished and commercial purposes, it is termed and thereafter referred to as “Jack Chan's Wide Range Rear View Mirror” or in abbreviation “JC Wide Range Rear View Mirror” or “JC Mirror.”

Accordingly, it is an objective of this invention to provide a safety driving on roadways.

It is further object of this invention to provide a safety device to the new and the existing motor vehicles on the roads.

It is further object of this invention to provide a rear full view to the drivers of all types of motor vehicles.

It is yet a further object of this invention to provide an improvement of safety to the various type of motor cars.

It is yet a further object of this invention to provide an improvement of safety to the various types of vans.

It is yet a further object of this invention to provide an improvement of safety to various types of trucks.

It is yet a further object of this invention to provide an improvement of safety to various types of buses.

It is yet a further object of this invention to provide an improvement of safety to various types of trailers.

### BRIEF DESCRIPTION OF DRAWINGS

A better understanding of the present invention can be obtained from the detailed description of exemplary embodiments set forth below to be considered in conjunction with the attached drawings, in which:

FIG. 1 depicts the design of the Wide Range Rearview Mirror for left and right with cover holder and hanger for motorcars.

FIG. 2 depicts the design of the Wide Range Rearview Mirror with internal coil spiral for folding closed and open flat.

FIG. 3 depicts the present ordinary flat view mirror from which the vehicle could have only 80°-90° rearview.

FIG. 4 depicts the invented Wide Range Rearview Mirror from which the vehicle drivers could have a full rearview covering of 100°-120° range.

FIG. 5 depicts the designed size of the wide range rearview mirror for cars. The size is four (4) inches in width, seven (7) inches in length and ¼″ in central curve gradually and equally reducing and meeting both the edges.

FIG. 6 depicts the design of Wide Range Rearview Mirror with cover, holder and hanger for vans and trucks.

FIG. 7 depicts the size of the Wide Range Rearview Mirror for vans and trucks are five (5) inches in width and seven (7) inches in length. The central curve is ¼″ and gradually reducing and meeting the edges. The range view covers 100°-120°.

FIG. 8 depicts the design of Wide Range Rearview Mirror with cover, holder and hanger for buses and trailers.

FIG. 9 depicts the size of the Wide Range Rearview Mirror for buses and trailer.

The size is (7) inches in width and twelve (12) inches in height. The central curve is ⅜″ gradually extending to both sides reducing curve until meeting the edges.

FIG. 10 depicts the invented Wide Range Rearview Mirror is designed for the central curve of ¼″ or ⅜″ to move a little to the left, if it is the wide range rearview mirror for the left side of the vehicle. The range view covers 100°-140°.

FIG. 11 depicts the invented Wide Range Rearview Mirror is designed for the Central curve of ¼″ or ⅜″ to move a little to the right, if it is the wide range rearview mirror for the right side of the vehicle. The range view covers 100°-140°.

FIG. 12 depicts the invented Wide Range Rearview Mirror is designed for folding closed to avoid damage. Any object either crashing or hitting the mirror which will dissolve the force and folding closed.

FIG. 13 depicts the invented Wide Range Rearview Mirror is designed to open flat if it is crashed by an object, the damage is avoided.

FIG. 14 gives the illustration of the blind spots of the present rearview mirrors viewing from the driver's seat

FIG. 15 gives illustration of the full rearview of the invented Wide Range Rearview Mirror viewing from the driver's seat.

### BEST MODE FOR CARRYING OUT THE

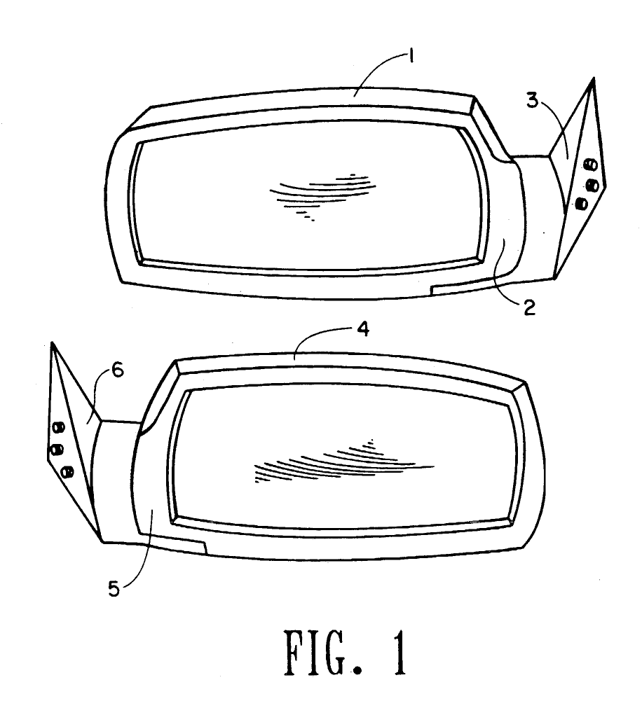

FIG. 1 depicts the appearance of the Wide Range Rearview Mirror, with cover (1), holder (2), and hanger (3) for connecting to the cars. This Wide Range Rearview Mirror is for attachment to the left side of the vehicles. The Wide Range Rearview Mirror with cover (4) holder (5) and hanger (6) is for connecting to the right side of the vehicles.

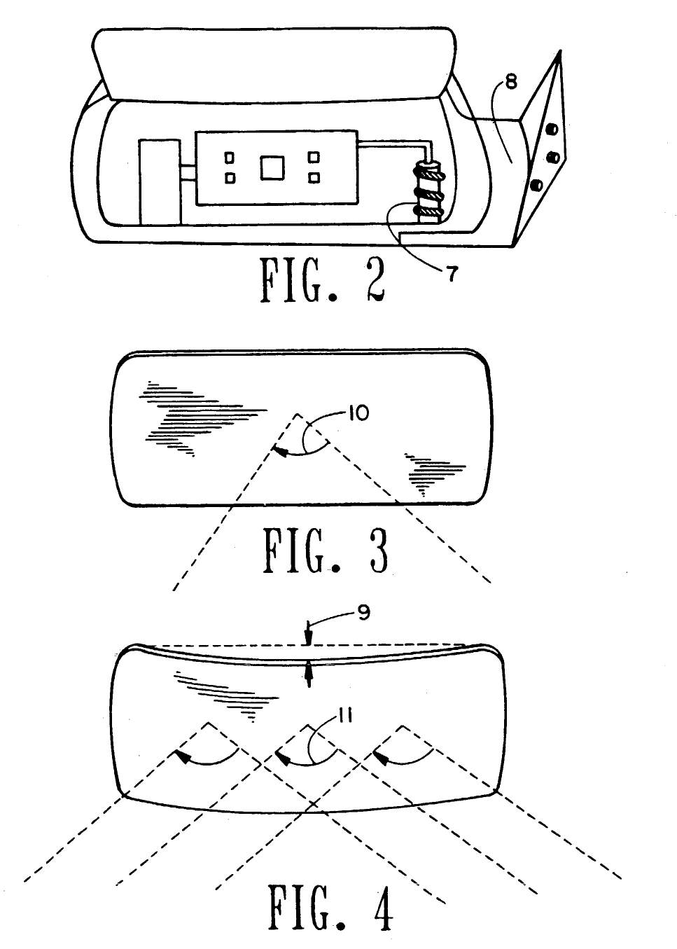

FIG. 2 depicts the internal features of the Wide Range Rearview Mirror where (7) indicates the mechanism of coil spirals for the Wide Range Rearview Mirror to fold closed and open flat when it is crashed or hit by an object. The hanger for connecting to the vehicle is indicated (8) therein.

FIG. 3 depicts the present flat rearview mirror, which only covers about 80°-90° range (10) of the rearview mirror. This is the major shortcoming of the ordinary rearview mirror.

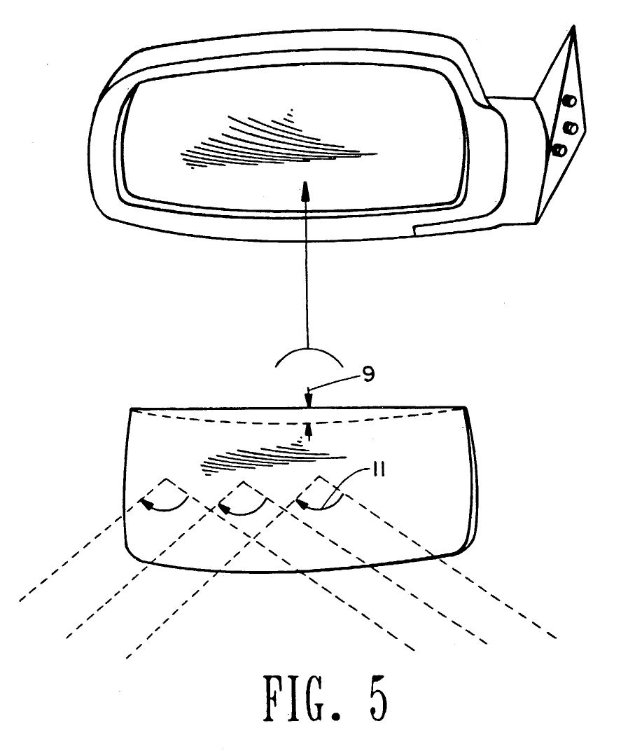

FIG. 4 depicts the Wide Range Rearview Mirror itself. It has ¼″ central curve (9) gradually reducing and reaching the edges. The rearview covers 100°-120° (11) because of its curve surface reflecting the rear full view left or right viewing from the driver's seat. Having the full rearview, the driver could change lanes without worries of a vehicle suddenly emerging from his/her left and crashing onto, if he/she is making or entering into the left lane. Having the full rearview, the driver could change lane without worries of a vehicle suddenly appearing and shocking him/her on the right and crash on, if he/she is making a right entrance into the right lane.

FIG. 5 depicts the appearance and the size of the Wide Range Rearview Mirror for motorcars. The measurement of the wide range of the curve mirror is four (4) inches in width and seven (7) inches in length with ¼″ center curve (9) which is gradually extended to both sides and meeting the edge. The curved mirror is providing the capacity to cover a wide range of 100°-120° rearview (11). With the full rearview without blind spots, the driver could monitor the traffic flow around him/her every minute.

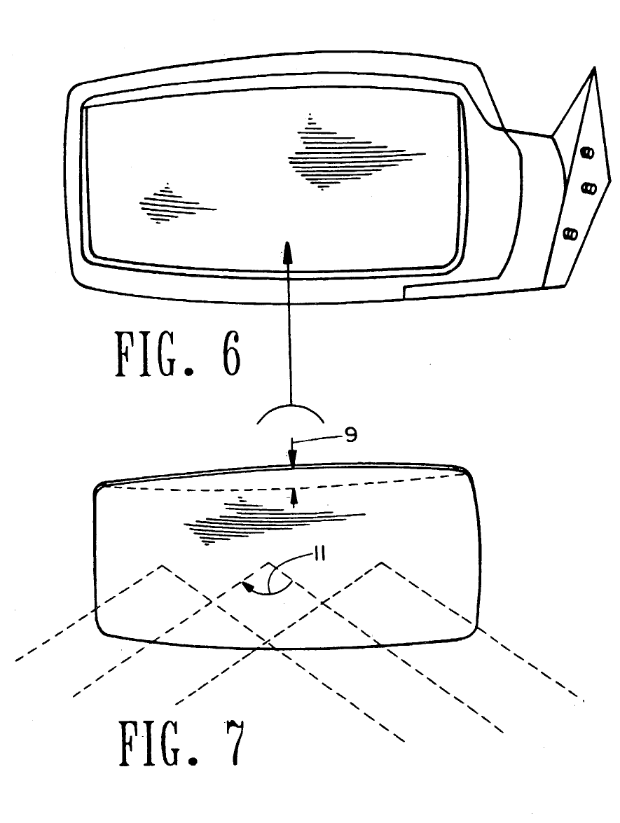

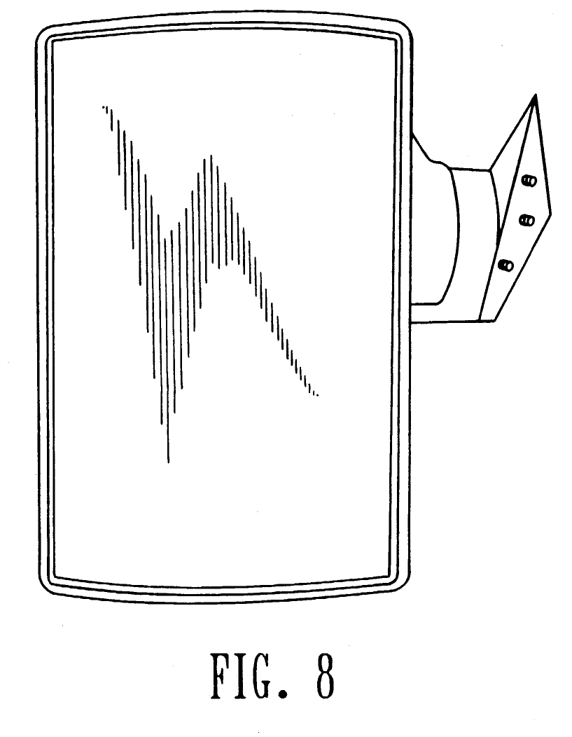

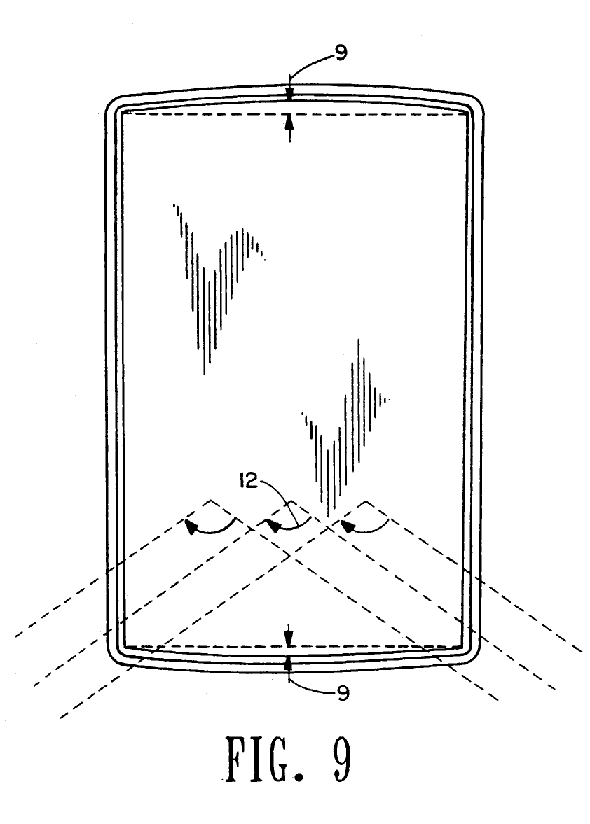

The design of the Wide Range Rearview Mirror for vans and trucks is depicted in FIG. 6 while FIG. 7 shows the size of the Wide Range Rearview Mirror for vans and trucks. The measurements, are five (5) inches in width and seven (7) inches in length. The center curve is ¼″ (9) gradually extended to reach the both edges. The range of coverage is 100°-120° of rearview (11), which is full wide rearview without blind spots. FIG. 8 depicts the design of the Wide Range Rearview Mirror in rectangular shape for buses and trailers. Whereas FIG. 9 depicts the size of the Wide Range Rearview Mirror for buses and trailers. The size is seven (7) inches in width and twelve (12) inches in height. The center curve is ⅜″ or ¼″ (9) gradually extended to both sides and reducing the curve until meeting the edges. The range of rearview coverage is 120°-140° (12). It is a full range rearview enabling the driver to see the traffic flow in every movement and to maneuver his vehicle easily.

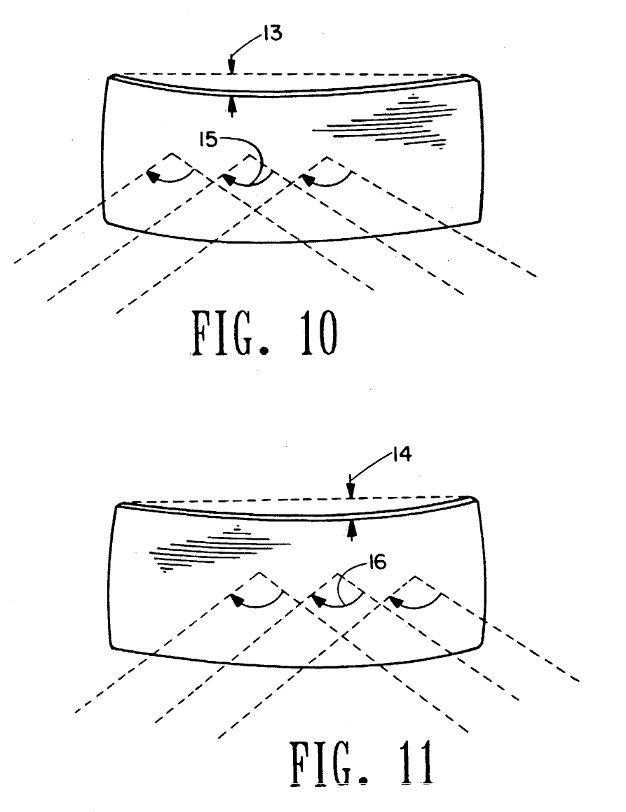

FIG. 10 depicts the invented Wide Range Rearview Mirror designed for the center curve of ¼″ or ⅜″ move a little to the left (13), if it is the Wide Range Rearview Mirror for the left side. With the adjustment, the range view could increase to 100°-140° (15) and similarly, FIG. 11 depicts the center curve (14) move a little to the right providing little wider range of coverage. With the adjustment, the rearview could increased to 100°-140° (16). It has been experienced that many rearview mirrors are broken due to crashing or hitting by an object. These could occur while vehicles are moving or parking. Where FIG. 12 depicts the invented Wide Range Rearview Mirror is designed for folding closed to avoid damage. Any object either crashing or hitting the mirror, which will dissolve the force and fold closed. Similarly, if the driver is not careful, the rear mirror hits an object, it could easily fold closed (17). When the driver is not careful, the rearview mirror would either hit the divider of the garage or other objects.

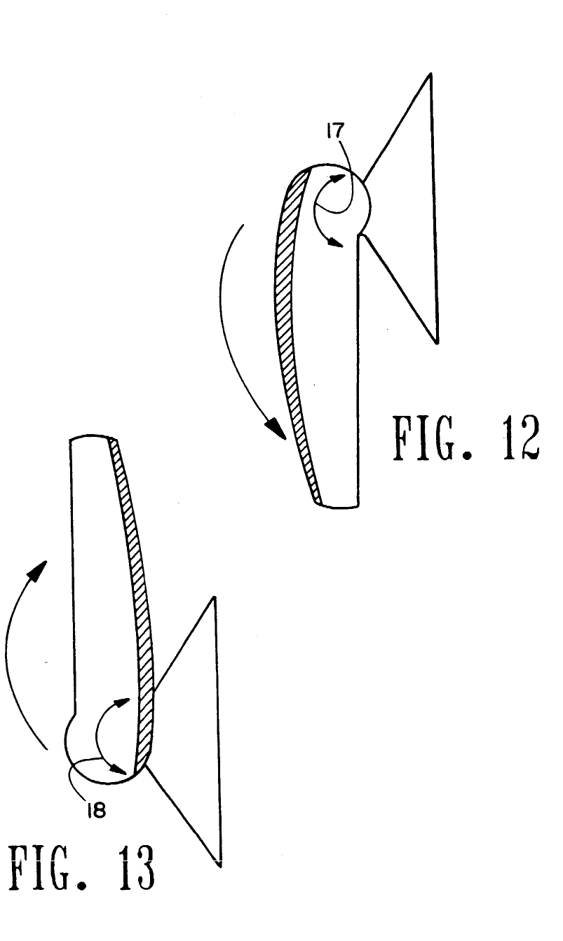

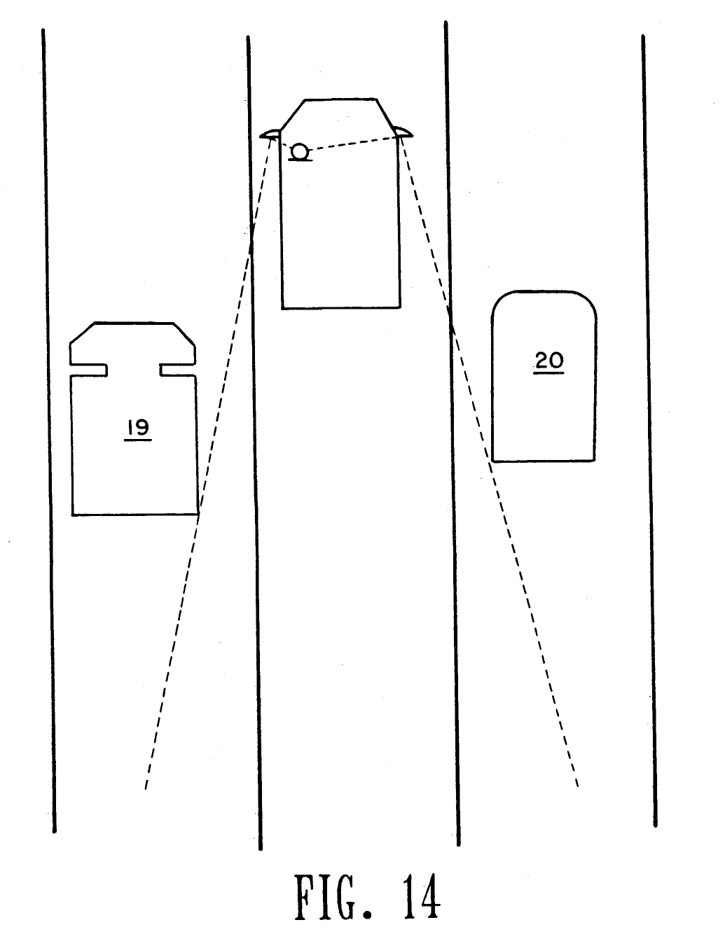

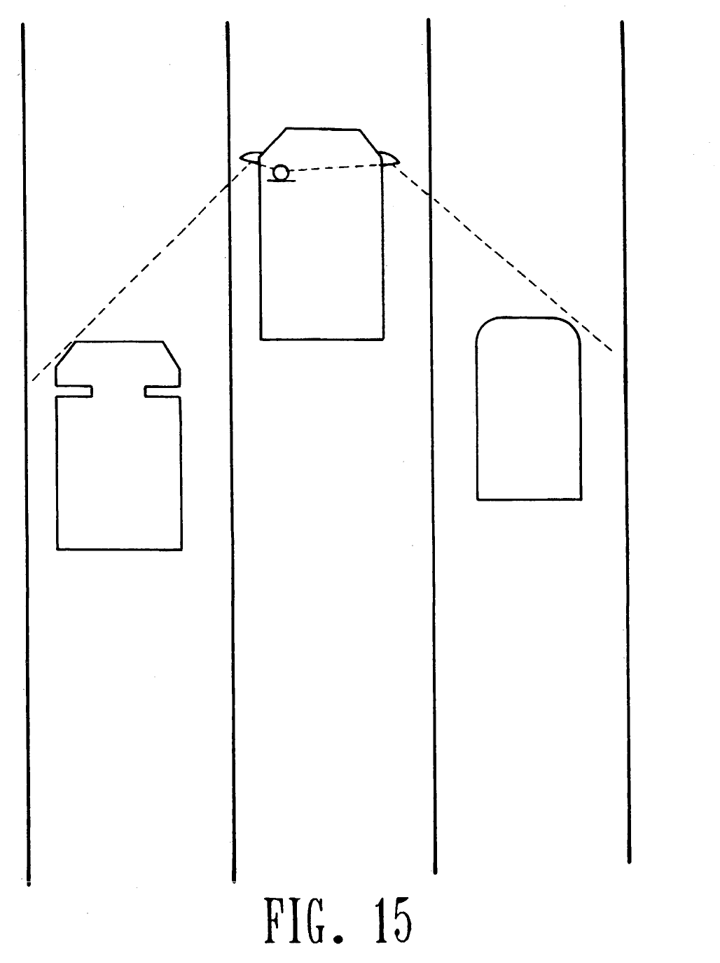

With this mechanism (7) indicated earlier in FIG. 2, the Wide Range Rearview Mirror is saved It was also happened that the rearview mirror of passing vehicle hit the rearview mirror of a station vehicle. FIG. 13 depicts the invented Wide Range Rearview Mirror, which is designed for opening flat if it is crashed or is hit by a passing by vehicle. This mechanism (7) in FIG. 2, avoiding damages is provided by a turning and folding mechanism attached to the holder of the mirror. FIG. 14 is an illustration of the blind spots of the present rearview mirrors. The areas marked in lines are the blind spots (19) and (20) of the rearview mirror. More often than not, accidents occur when the driver is not alert and careful while changing lanes. It is because the vehicle at the right lane or left lane already entered into the blind spot of his rearview mirror. Whereas FIG. 15 gives an illustration of the full rearview of the invented Wide Range Rearview Mirror viewing from the driver's seat. The blind spots indicated in FIG. 14 are now totally eliminated. With the installation of the invented Wide Range Rearview Mirrors, the drivers of vehicles such as cars, vans, trucks, buses and trailers could have the full rearview. The road accidents could naturally be cut down.

Industrial Application

The JC Wide Range Rearview Mirror could be installed for new vehicles by the car manufactures around the world with a negligible cost. The real cost could be the same as the existing flat rearview mirrors. The JC Wide Range Rearview Mirror could also replace the existing old flat rearview mirrors by the motor vehicle owners. The selling price could be the same or slightly higher by 10%-20% after the new feature is added in such as folding closed and opening flat for which new technique is required. New technique is also required to manufacturer the curved mirrors. A total of 10%-20% additional cost is estimated.

The additional cost of 10%-20% of manufacturing the wide range rearview mirror and may be only 10% will be reflected in the in selling price. However, by installing the wide range rearview mirrors, the vehicle drivers could receive the added benefit of the improved safety and convenience. The benefits of installing the JC Wide Range Rearview Mirrors are greater than the simple one to one correspondence to the increase of manufacturing cost. Thus, a 10% increase on cost of manufacturer of the Wide Range Rearview Mirror yields greater than 10% benefit, in term of safety, life and property lost due to accidents.

In most of the developing countries, congestion, emissions, lack of manner and lack of traffic control, vehicles on the roads are always trying to overpass the front vehicles, the driver in haste, while overpass were hit by the side vehicle hiding in the blind spot. The life and property lost resulting insurance claims is tremendous. With the application of the instant invention, the driving safety is thus enhanced. This invention should have some kind of support from the vehicles' insurance companies worldwide.

1. An invented rearview mirror for motor vehicles comprises a Wide Range Rearview Mirror with a mechanism of folding closed and opening flat of the whole piece attached to the hanger. Wherein the said mirror with a center curve is gradually reducing and extended to the both sides edges. The said mirror provides a wide range rearview for the vehicle drivers and the said mirror covers the full rearview without blind spots viewing from the seat of the vehicle driver.

2. The invented Wide Range Rearview of claim 1 wherein the center curve of the said mirror would be ¼″ in height gradually reducing and extended to both sides and reaching the edges providing a wide range rearview to the vehicle driver as Pattern I.

3. The invented Wide Range Rearview Mirror of claim 1 wherein the center curve of the said mirror would be ⅜″ or ⅓″ in height gradually reducing and extended to both sides and reaching the edges providing a wide range rearview to the vehicle driver as Pattern I.

4. The invented Wide Range Rearview Mirror of claim 1 wherein the size of the mirror could be seven (7) inches in width and four (4) inches in height with a center curve of ¼″ providing a wide range rearview to the driver.

5. The invented Wide Range Rearview Mirror of claim 1 the size of the mirror could be seven (7) inches in width and five (5) inches in height with a center curve of ¼″ providing a wide range rearview to the driver.

6. The invented Wide Range Rearview Mirror of claim 1 wherein the size of the mirror could be seven (7) in width and six (6) inches in height with a center curve of ⅜ or ⅓ providing a wide range rearview to the driver.

7. The invented Wide Range Rear View Mirror of claim wherein the size of the mirror could be seven (7) inches in width and twelve (12) inches in height with a center curve ⅜″ or ⅓″ providing a wide range rearview to the driver.

8. The invented Wide Range Rear View Mirror of claim 1 wherein the size and shape could be any and with the center curve point of any height moving a little to the left, providing wide range rearview to the driver, if it is for the left side of the vehicle as Pattern II.

9. The invented Wide Range Rear View Mirror of claim 1 wherein the size and shape could be any and with the center curve point of any height moving a little to the right, providing wide range rearview to the driver, if it is for installation to the right side of the vehicle as Pattern II.

10. The invented Wide Range Rear View Mirror of claim 1 wherein the size and shape could be any with the curve point move further to the left. The central surface become a flat mirror with a little bend curve at the left, if the rearview mirror is for the left side of the vehicle as Pattern III.

11. The invented Wide Range Rear View Mirror of claim 1 wherein the size and shape could be any with the curve point move further to the right. The central surface become a flat mirror with a little bend curve at the right, if the rearview mirror is for the right side of the vehicle as Pattern III.

12. The invented Wide Range Rear View Mirror of claim 1 wherein cover holder connected to the vehicle is with the mechanism attached to the holder to fold closed when it is crashed or hit by an object.

13. The invented Wide Range Rear View Mirror of claim 1 wherein the cover holder connected to the vehicle is made with the mechanism providing the mirror to open flat when it is crashed or hit by an object.

14. The jurisdiction of this invented Wide Range Rear View Mirror of claim 1, claim 8, claim 9, claim 10, and claim 11 covers the rear view mirror of motor cycles.
